(19) United States
(12) Patent Application Publication
(10) Pub. No.: US 2003/0050124 A1
(43) Pub. Date: Mar. 13, 2003

(54) Outer race for constant-velocity joints and manufacturing method therefor

(75) Inventors: Hisanobu Kanamaru, Sagamihara-Shi (JP); Nobuyuki Ishinaga, Sagamihara-Shi (JP)

Correspondence Address: Joseph R. Robinson, Darby & Darby, P.C., PO Box 5257, New York, NY, 10150-5257, US

(73) Assignee: AIDA ENGINEERING CO., LTD.

(21) Appl. No.: 10/232,797

(22) Filed: Aug. 29, 2002

(30) Foreign Application Priority Data
Sep. 10, 2001 (JP) 2001-273004

(51) Int. Cl. F16D 3/26

(52) U.S. Cl. 464/111

(57) ABSTRACT

An outer race for constant-velocity joints is provided and is high precision, lightweight, and rotationally well balanced and a method of manufacturing the same is also provided. Another object is to provide an outer race for constant velocity joints that does not place an excessive load on the mold used and a method of manufacturing the outer race. The present exemplary process employs a blank that is obtained by a forging method and that therefore is isotropic in the circumferential direction. Additionally, the blank is formed into an outer race using forward extrusion.

### TECHNICAL FIELD

The present invention relates to an outer race for constant-velocity joints and a method of manufacturing the same. A “constant-velocity joint” is used in wheel axles for automobiles, e.g., tripod-type constant-velocity joints, double-offset constant-velocity joints, and birfield constant-velocity joints. An “outer race” is a component of the constant-velocity joints having a housing provided with tracks and ball grooves.

### BACKGROUND

A tripod-type constant-velocity joint is described in Unexamined Patent Application H11-101257. A double-offset constant-velocity joint and birfield constant-velocity joint are described in Unexamined Patent Application H8-49727 and Unexamined Patent Application H1-261520, respectively.

The outer race of such constant-velocity joints is conventionally formed by the backward extrusion of a cylindrical blank, a cylindrical blank given a stepped shape or by the drawing of a plate material.

Problems with the prior art outer races include a tendency of eccentricity to exist between the inner and outer diameters that result in poor balance as a rotating element. Conventional outer races of the prior art tend to be molded with excess material, which adds needless weight. Additionally, there is a considerable load placed on the metal mold used to form the outer race and this results in shorting the lifespan of the mold. Problems with the molding method of the prior art include the occurrence of trimmings on the edges of the drawn article. These trimmings are formed due to the plate material's anisotropy and warping after forming. The trimmings, the anisotropy and the warping all result in substandard precision of the races. Lastly, conventional molds are difficult when dealing with variable material thickness and are of insufficient strength.

### SUMMARY

One object of the present apparatus is to provide a high-precision, lightweight, and rotationally balanced outer race for constant-velocity joints and a method of manufacturing the joints is likewise provided. Another object is to provide an outer race for constant-velocity joints that does not place an excessive load on molds and a method of manufacturing the outer race.

Regarding these objects, a blank, obtained by a forging method is used and is shaped to manufacture the outer race. The blank is forged so it will be isotropic in the circumferential direction.

Patent Application JP-2000-093345, recites a similar method, and was filed by the present applicant. Application JP-2000-093345 concerns a shaft-mounted gear, which differs from the outer race for constant-velocity joints with which the present application is concerned, the manufacturing methods are similar.

More specifically, an outer race for constant-velocity joints is provided that is formed from an article formed by a forging method. The outer race has a shaft and a flange, and the thickness of the base of the flange is approximately the same as the thickness of the finished article. Additionally, an outer race for constant-velocity joints can be formed as above and wherein drawing the article forms a cup-shaped intermediate article. The tracks and ball grooves can be formed by subjecting the intermediate article to extrusion that forms the housing into a predetermined shape with a relative low load.

The method of manufacturing for an outer race for constant-velocity joints includes forming the joints from an article made by a forging method. The joint has a shaft and a flange, and the thickness of the base of the flange is approximately the same as the thickness as the finished article. Additionally, the joint can be formed by taking a cup-shaped intermediate article and extruding the article to form tracks and ball grooves.

Any of the outer races for constant-velocity joints above can also include a bottom of the housing not being round but of a shape similar to that of the external shape of the housing. Also, any of the above outer races can be forged by cold forging.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a cross-sectional view of the first stage of formation of the outer race for constant-velocity joints of a first embodiment;

FIG. 2(a) is a top view of the outer race of FIG. 2(b);

FIG. 2(b) is a cross-sectional view of the second stage of formation for the outer race of the first embodiment;

FIG. 3(a) is a top view of the outer race of FIG. 3(b);

FIG. 3(b) is a cross-sectional view of the final stage of formation for the outer race of the first embodiment;

FIG. 4 is a front and side perspective view of the final outer race according to the first embodiment;

FIG. 5 is a cross-sectional view of the first stage of formation of the outer race for constant-velocity joints of a second embodiment;

FIG. 6(a) is a top view of the outer race of FIG. 6(b);

FIG. 6(b) is a cross-sectional view of the second stage of formation for the outer race of the second embodiment;

FIG. 7(a) is a top view of the outer race of FIG. 7(b);

FIG. 7(b) is a cross-sectional view of the final stage of formation for the outer race of the second embodiment; and

FIG. 8 is a front and side perspective view of the final outer race according to the second embodiment.

### DETAILED DESCRIPTION OF PREFERRED EMBODIMENTS

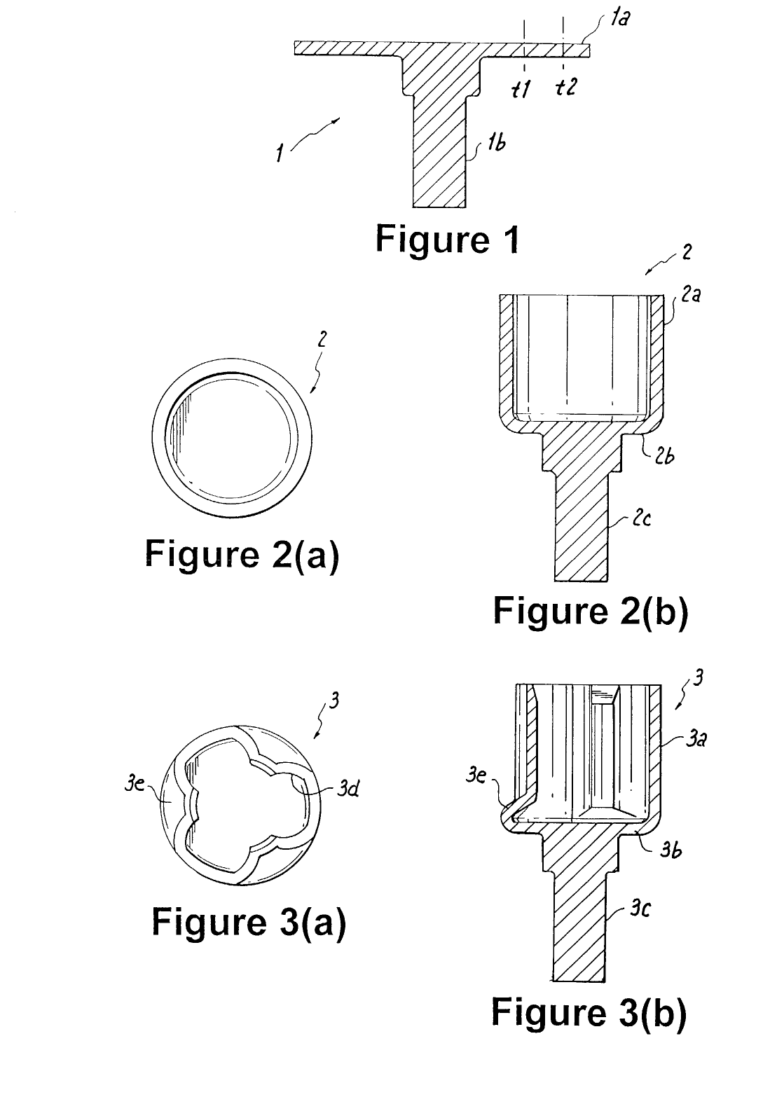

Referring now to FIGS. 1-3, the process of forming a tripod-type constantvelocity joint is illustrated. A blank 1 comprises a flange 1a and a shaft 1b. Blank 1 is made from cylindrical material using an extrusion-and-swaging forming method. Therefore, flange 1a is uniform, i.e., isotropic, in the circumferential direction. Blank 1 may be forged by hot forging, warm forging, and cold forging. The relative advantages and disadvantages of each forging method are widely known by those of skill in the art.

Blank 1 includes shaft 1b, which becomes a shaft 3c of a finished article 3, and flange 1a becomes a housing 3a. Flange 1a is formed by compressing the cylindrical element. The thickness of the base of flange 1a is approximately the same as that of a bottom 3b of finished article 3. It is necessary to form a thickness t1 of the base of flange 1a to be approximately the same as that of bottom 3b.

A thickness t2 of another portion of flange 1a is about 10% greater than that of housing 3a of finished article 3. Although subsequent processing is not included in the present embodiment, splining of shaft 1b and imparting stepped shape are also possible.

Referring to FIGS. 2(a) and 2(b), blank 1 is drawn to form an intermediate article 2. One method to form intermediate article 2 is described below. Blank 1 is placed on a die (not illustrated) having a tapered cavity and pressed in with a punch (not illustrated) having an outer diameter corresponding to the inner diameter of a cup-shaped portion 2a of intermediate article 2. The die and punch transform blank 1 into intermediate article 2.

Intermediate article 2 is next inserted upside-down into a female mold (not illustrated) comprising a die the hole of which has the same exterior shape as housing 3a and an upwardly and downwardly movable counterpunch (not illustrated), the exterior shape of which is the same as the interior shape of housing 3a. Intermediate article 2 is then pressed in with a ring-shaped punch (not illustrated) that presses against a bottom 2b of intermediate article 2. This pressure causes the forward extrusion that transforms intermediate article 2 into finished article 3.

The forward extrusion primarily involves the forming of tracks 3d. This reduces the degree of forming (processing) finished article 3 and reduces the load applied to the mold. By reducing the degree of forming and load, the lifespan of the mold can be increased above that of the prior art methods.

Although the present application describes a process whereby blank 1 is transformed into intermediate article 2 by means of drawing, intermediate article 2 may also be formed by ironing.

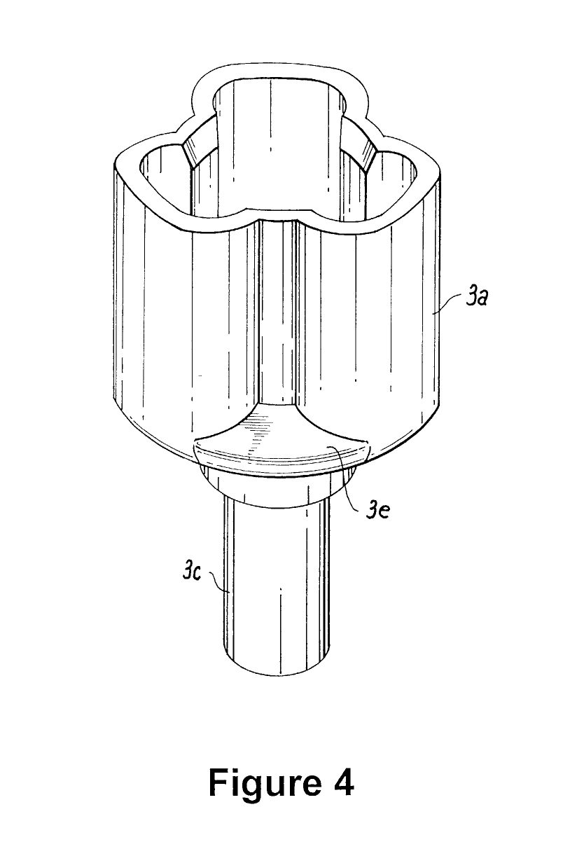

Referring to FIGS. 3(b) and 4, an unpressed portion 3e of finished article 3 is formed by compression caused by the pressing action of the shoulder of said die cavity and the end of said ring-shaped punch.

Although the interior shape and exterior shape of unpressed portion 3e are not constrained by the mold, the three unpressed portions are given approximately the same shape and dimensions by the method recited in the present application.

FIG. 4 is a front and side perspective view of finished article 3 as shown in FIGS. 3(a) and 3(b). Finished article 3, illustrated in FIGS. 3(a), 3(b) and 4, has a diagonal chamfering at the ends or the opening of housing 3a. The chamfers may be formed by forward extrusion.

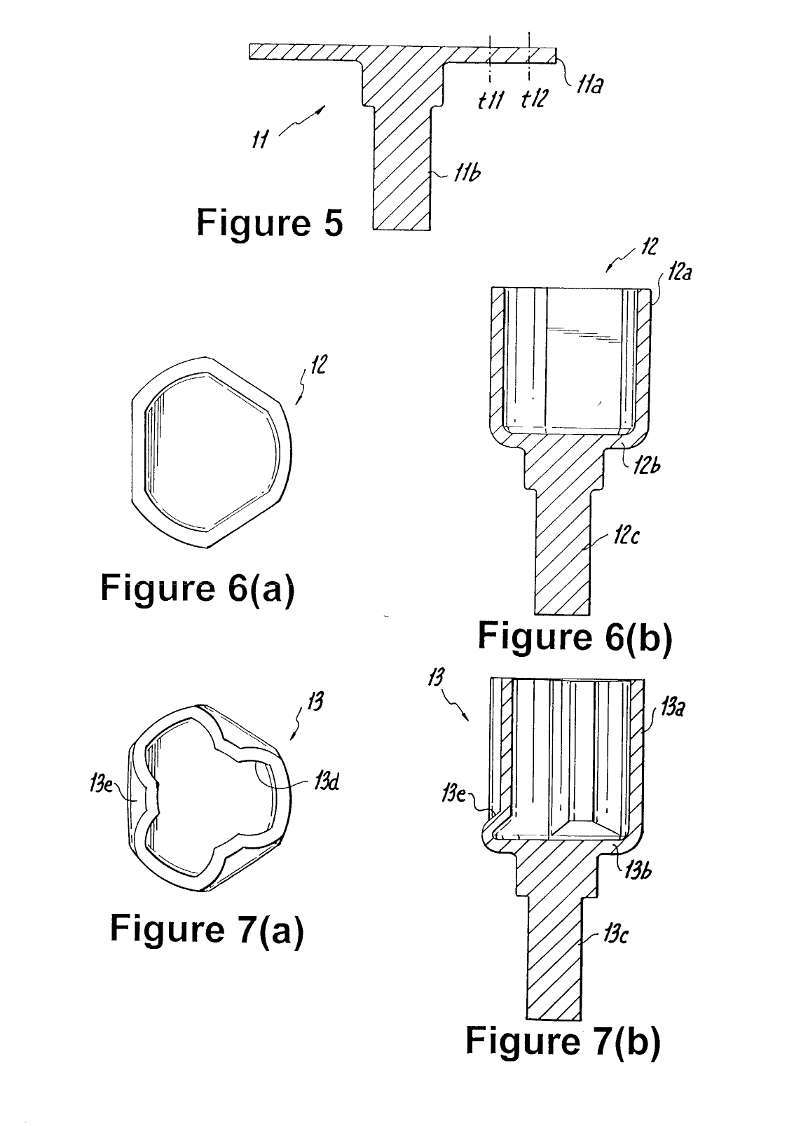

FIGS. 5-7 illustrate the process of the second embodiment of the present invention. The second embodiment differs from the first embodiment in that the bottoms of the intermediate article and finished article are not round in shape. However, the second embodiment is otherwise manufactured the same as the first embodiment, e.g., extrusion is performed after drawing, and a blank 11 is obtained by means of extrusion and swaging of cylindrical material.

FIGS. 6(b) and 7(b) illustrate the respective bottoms 12b, 13b of an intermediate article 12 and a finished article 13 are not round but rather of the same shape as a housing 13a. The shape of the bottoms results from cutting a portion of a round member. Therefore, the dimensions of an unpressed portion 13e are small, providing such advantages as being beneficial with regard to reducing product weight.

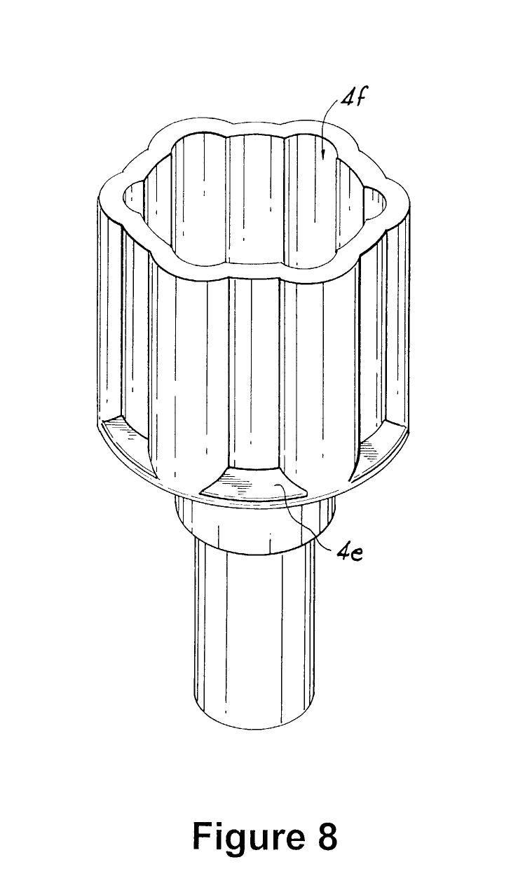

FIG. 8 is a front and side perspective drawing of a double-offset finished article that includes a ball groove 4f. A similar process, as above, forms the finished article as illustrated in FIG. 8. Although the preceding examples involve tripod-type and double-offset constant-velocity universal joints, an outer race for birfield constant-velocity joints may be formed in essentially the same manner. That is, the outer race can be formed in the same manner as that of the aforesaid embodiments by drawing and then extruding a blank so as to form ball grooves 4f. However, because ball grooves 4f are undercut or have a shape such that a portion having a larger diameter than the cavity exists in the interior, a sizing process should be performed after extrusion. The ball grooves may be undercut by means of sizing.

The present process of utilizing a blank made by forging produces a finished article that is isotropic in the circumferential direction and has no eccentricity. This yields a product that does not deform after forming and therefore has high precision and good rotational balance.

Another aspect of the present process requires drawing prior to extrusion and therefore involves a low degree of forming in extrusion. Thus, the mold used is subjected to only a light load and that results in a long lifespan for the mold.

To reduce the weight and to lower the load required to form finished article 3, bottom 3b of finished article 3 is not round in shape but rather approximates the outer shape of housing 3a that results in a small unpressed portion 3e.

A further aspect of the present process employs a blank 1 obtained by cold forging, this results in a high-precision final product.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. An outer race for constant-velocity joints comprising:
a forged blank including:
a shaft; and
a flange integral to the shaft, wherein a thickness of a base of the flange is substantially equal to a thickness of a bottom of the outer race.

2. The outer race for constant-velocity joints according to claim 1, further comprising:
an intermediate article formed from drawing the forged blank, the intermediate article including:
a cup-shaped portion;
a plurality of tracks formed on the cup-shaped portion; and
a plurality of ball grooves formed on the cup-shaped portion; wherein the cup-shaped portion, the tracks, and the ball grooves form a housing of the outer race.

3. The outer race for constant-velocity joints according to claim 2, wherein the housing of the outer race includes a housing bottom having a shape substantially similar to the housing.

4. The outer race for constant-velocity joints according to claim 1, wherein the forged blank is cold forged.

5. The outer race for constant-velocity joints according to claim 1, wherein the flange comprises a second thickness being greater than a first thickness of a housing of the outer race.

6. The outer race for constant-velocity joints according to claim 5, wherein the second thickness is about 10% greater than the thickness of the housing.

7. A method of manufacturing an outer race for constant-velocity joints comprising the step of forging a blank having a shaft and a flange.

8. The method of manufacturing an outer race for constant-velocity joints according to claim 7, further comprising the step of:
forming a cup-shaped intermediate article by drawing the blank; and forming a plurality of tracks and a plurality of ball grooves.

9. The method of manufacturing an outer race for constant-velocity joints according to claim 8, further comprising the step of:
forming a housing from the cup-shaped intermediate article, wherein the intermediate article comprises a bottom having a shape substantially similar to the housing.

10. The method of manufacturing an outer race for constant-velocity joints according to claim 7, wherein the forging step is cold forging.

11. A method of manufacturing an outer race for constant-velocity joints comprising the steps:
(a) forging a blank having a shaft and a flange, wherein a thickness of a base of the flange is substantially equal to a thickness of the bottom of the outer race;
(b) drawing the blank to form a cup-shaped portion;
(c) forming a plurality of tracks and a plurality of ball groves on the cup-shaped portion; and
(d) forming a housing from the cup-shaped portion, wherein a thickness of a bottom of the housing being substantially equal to the thickness of the flange, and a shape of the bottom is substantially equal to a shape of the housing.
